(19) United States
(12) Patent Application Publication
(10) Pub. No.: US 2016/0206994 A1
(43) Pub. Date: Jul. 21, 2016

(54) METHOD AND APPARATUS FOR REMOVING CARBON DIOXIDE FROM FLUE GAS

(71) Applicant: REID SYSTEMS (AUSTRALIA) PTY LTD, Burswood, Western Australia 6100 (AU)

(72) Inventor: Terrence Reid, Bibra Lake, Western Australia (AU)

(21) Appl. No.: 15/023,660

(22) PCT Filed: Oct. 7, 2014
(86) PCT No.: PCT/AU2014/000958

§ 371 Date: Mar. 21, 2016

(30) Foreign Application Priority Data
Oct. 7, 2013 (AU) 2013903852

(51) Int. Cl. B01D 53/62; B01D 53/73; G06Q 30/00; B01D 53/50; C05C 3/00; G06Q 40/04; B01D 53/78; B01D 53/56

(52) U.S. Cl. CPC B01D 53/62; B01D 53/78; B01D 53/73; B01D 53/565; B01D 53/508; C05C 3/00; G06Q 40/04; G06Q 30/018; B01D 2251/2062; B01D 2258/0283

(57) ABSTRACT

A method and apparatus for removing carbon dioxide from a flue gas is disclosed. The method comprises contacting the flue gas with an ammoniated solution to produce an ammonium bicarbonate solution and contacting the ammonium bicarbonate solution with a sulphate source to produce a carbonate compound and an ammonium sulphate solution.

The apparatus comprises a gas-liquid absorption zone configured for contacting the flue gas with an ammoniated solution to produce an ammonium bicarbonate solution; the gas-liquid absorption zone having respective inlets to receive the flue gas and the ammoniated solution in the gas-liquid absorption zone, and an outlet for egress of the ammonium bicarbonate solution. The apparatus also includes a reactor configured for contacting the ammonium bicarbonate solution with a sulphate source to produce a carbonate compound and an ammonium sulphate solution; the reactor having respective inlets to receive the ammonium bicarbonate solution and the sulphate source in the reactor, and an outlet for egress of the carbonate compound and ammonium sulphate solution.

The method and apparatus can be adapted for producing fertilizer from flue gas by utilizing the ammonium sulphate solution in a process to produce a fertilizer product.

### FIELD

The present invention relates to a method and apparatus for removing carbon dioxide from flue gas. The present invention also relates to a method and system for producing fertilizer from flue gas.

### BACKGROUND

Flue gas from power plants, industrial plants, refineries and so forth are a major source of greenhouse gases, in particular carbon dioxide. There are several chemical processes and scrubbers which are routinely used to treat flue gas to remove pollutants such as particulates, heavy metal compounds, nitrogen oxides and sulphur oxides to comply with regulations for environmental emissions control. However, there is an ongoing need for technologies directed to methods and systems for capture and storage of carbon dioxide that are economically viable.

One commercially proven process for the recovery of carbon dioxide from flue gas uses commercial absorbents comprising monoethanolamine (MEA) and other primary amines. These absorbents are capable of recovering 85-95% of the carbon dioxide in flue gas and produce a 99.95+% pure carbon dioxide product when regenerated. However, these absorbents require regular regeneration which has an energy cost associated therewith, and the absorbents are subject to corrosion and solvent degradation problems over time.

There is therefore a need for alternative or improved methods and systems for removing carbon dioxide from flue gas.

### SUMMARY

According to a first aspect, there is provided a method of removing carbon dioxide from a flue gas, the method comprising;

a) contacting the flue gas with an ammoniated solution to produce an ammonium bicarbonate solution; and,

b) contacting the ammonium bicarbonate solution with a sulphate source to produce a carbonate compound and an ammonium sulphate solution.

In one embodiment, the method may further comprise the step of recovering the carbonate compound by separating the carbonate compound from the ammonium sulphate solution.

In a preferred embodiment, the carbonate compound is calcium carbonate.

According to a second aspect, there is provided an apparatus for removing carbon dioxide from a flue gas, the apparatus comprising:
a gas-liquid absorption zone configured for contacting the flue gas with an ammoniated solution to produce an ammonium bicarbonate solution;
the gas-liquid absorption zone having respective inlets to receive the flue gas and the ammoniated solution in the gas-liquid absorption zone, and an outlet for egress of the ammonium bicarbonate solution; and,
a reactor configured for contacting the ammonium bicarbonate solution with a sulphate source to produce a carbonate compound and an ammonium sulphate solution;
   the reactor having respective inlets to receive the ammonium bicarbonate solution and the sulphate source in the reactor, and an outlet for egress of the carbonate compound and ammonium sulphate solution.

In one embodiment, the system may further comprise a separator for separating the carbonate compound from the ammonium sulphate solution.

According to a third aspect, there is provided a method of producing fertilizer from flue gas, the method comprising:

a) contacting the flue gas with an ammoniated solution to produce an ammonium bicarbonate solution;

b) contacting the ammonium bicarbonate solution with a sulphate source to produce a carbonate compound and an ammonium sulphate solution;

c) separating the carbonate compound from the ammonium sulphate solution; and,

d) utilizing the separated ammonium sulphate solution in a process to produce a fertilizer product.

According to a fourth aspect, there is provided an apparatus for producing fertilizer from flue gas, the apparatus comprising:

a gas-liquid absorption zone configured for contacting the flue gas with an ammoniated solution to produce an ammonium bicarbonate solution;
the gas-liquid absorption zone having respective inlets to receive the flue gas and the ammoniated solution in the gas-liquid absorption zone, and an outlet for egress of the ammonium bicarbonate solution;
a first reactor configured for contacting the ammonium bicarbonate solution with a sulphate source to produce a carbonate compound and an ammonium sulphate solution;
   the first reactor having respective inlets to receive the ammonium bicarbonate solution and the sulphate source in the reactor, and an outlet for egress of the carbonate compound and ammonium sulphate solution;
a separator to separate the carbonate compound from the ammonium sulphate solution; and,
a second reactor configured for utilizing the ammonium sulphate solution in a process to produce a fertilizer product.

### BRIEF DESCRIPTION OF THE DRAWINGS

Notwithstanding any other forms which may fall within the scope of the system and method as set forth in the Summary, specific embodiments will now be described, by way of example only, with reference to the accompanying drawings in which:

FIG. 1 is a schematic representation of a plant for removing carbon dioxide from flue gas, the plant having been adapted to produce fertilizer products;

FIG. 2a is a schematic representation of a NOx and SOx emissions control unit for use in the plant shown in FIG. 1;

FIG. 2b is an exploded view of the emissions control unit shown in FIG. 2a;

FIG. 2c is another schematic representation of the emissions control unit shown in FIGS. 2a and 2b;

FIG. 3 is a schematic representation of one embodiment of a first component of an apparatus for removing carbon dioxide from flue gas for use in the plant shown in FIG. 1;

FIG. 4 is a schematic representation of one embodiment of a second component of the apparatus for removing carbon dioxide from flue gas shown in FIG. 3 for use in the plant shown in FIG. 1;

FIG. 5 is a schematic representation of one embodiment of a third component of the apparatus shown in FIGS. 3 and 4, adapted to produce potassium sulphate fertilizer;

FIG. 6 is a schematic representation of one embodiment of a fourth component of the apparatus shown in FIGS. 3 to 5, adapted to produce potassium sulphate fertilizer; and,

FIG. 7 is a schematic representation of an alternative embodiment of the apparatus for removing carbon dioxide from flue gas.

### DETAILED DESCRIPTION

In one aspect, the present application relates to a method of removing carbon dioxide from flue gas.

Flue Gas

The term ‘flue gas’ is used broadly to refer to any gas exiting to the atmosphere via a flue, which is a pipe or channel for conveying exhaust gases produced by industrial or combustion processes. Generally, flue gas refers to the combustion exhaust gas produced at power plants fuelled by fossil fuels, such as coal, oil and gas. However, it will be appreciated that the term flue gas may refer to exhaust gases containing carbon dioxide produced by other industrial processes such as cement and lime production, steel production, incinerators, and the process furnaces in large refineries, petrochemical and chemical plants; and also to exhaust gases from various types of engines including, but not limited to, diesel engines, combustion engines, and gas-turbine engines.

The composition of flue gas depends on the combustion fuel or the type of industrial process which generates the flue gas. Flue gas may comprise nitrogen, carbon dioxide, carbon monoxide, water vapour, oxygen, hydrocarbons, and pollutants, such as particulate matter, nitrogen oxides (NOₓ) and sulphur oxides (SOₓ).

Removing Carbon Dioxide

The method of removing carbon dioxide from flue gas comprises:
a) contacting the flue gas with an ammoniated solution to produce an ammonium bicarbonate solution; and,
b) contacting the ammonium bicarbonate solution with a sulphate source to produce a carbonate compound and an ammonium sulphate solution.

Ammoniated Solution

The term ‘ammoniated solution’ broadly refers to any type of solution containing ammonia, such as a liquid solution, in particular an aqueous solution. The ammonia in the ammoniated solution may be in the form of ammonium ions and/or dissolved molecular ammonia. The solvent in the aqueous solution may be water, deionised water, ultrapure water, distilled water, municipal water, produced water, process water, brine, hypersaline water, or seawater.

The ammoniated solution may be prepared by sparging the solvent with a source of ammonia, such as anhydrous ammonia gas, to produce an ammonium hydroxide solution. Alternatively, the ammoniated solution may be prepared by mixing an ammonium hydroxide solution and/or an ammonium bicarbonate/carbonate solution with the solvent. Preferably, the concentration of ammonia in the ammoniated solution is in the range of about 5% w/v to about 30% w/v.

The pH of the ammoniated solution is in the range of about 9 to about 11, preferably in the range of about 9.5 to about 10.5. It will be appreciated that the ammoniated solution is self-buffering.

The ammoniated solution is maintained at a low temperature of from about 5° C. to about 30° C., preferably from about 10° C. to about 25° C. The ammoniated solution is kept at a low temperature to lower the partial pressure of ammonia in the headspace above the ammoniated solution. Advantageously, the low temperature of the ammoniated solution increases the capacity of the ammoniated solution to absorb carbon dioxide from the flue gas and to maintain the carbon dioxide in solution as bicarbonate/carbonate anions, as will be described later.

Contacting the Flue Gas with the Ammoniated Solution

Contacting the flue gas with the ammoniated solution may comprise passing the flue gas and the ammoniated solution through a gas-liquid absorption zone. The gas-liquid absorption zone can be configured for contacting the flue gas with an ammoniated solution to produce an ammonium bicarbonate solution.

In view of the speciation of the CO₂—NH₃—H₂O system, the term ‘ammonium bicarbonate solution’ refers to an aqueous solution of ammonium bicarbonate containing the following species in various relative concentrations, depending on the temperature, pressure, pH and concentration of carbon dioxide and ammonia in the ammonium bicarbonate solution: H⁺, OH⁻, NH₄⁺, HN₂COO⁻, HCO₃⁻, CO₃²⁻.

It will be appreciated that contacting the flue gas with the ammoniated solution to produce the ammonium bicarbonate solution facilitates absorption of carbon dioxide (and SOₓ and NOₓ gases, as will be described later) in the ammoniated solution. Absorption may be by physical absorption or chemisorption processes.

In physical absorption processes, carbon dioxide gas dissolves in the ammoniated solution. The solubility of the dissolved carbon dioxide gas will be dependent, at least in part, on the temperature and pressure of the ammoniated solution.

The primary chemisorption process relating to absorption of carbon dioxide in the ammoniated solution can be described as follows:

CO₂+(NH₄)OH(aq)→(NH₄)HCO₃

or alternatively as:

CO₂+NH₃+H₂O→(NH₄)HCO₃(aq)

Ammonium bicarbonate is thermally unstable and may dissociate to ammonia and carbon dioxide at temperatures above 36° C. Accordingly, the ammoniated solution is maintained at a temperature less than 32° C., preferably in a temperature range from about 5° C. to about 25° C. Advantageously, carbon dioxide is more soluble in the ammoniated solution in this temperature range.

In one embodiment, the ammoniated solution may be dispersed in the gas-liquid absorption zone in the form of a spray. The spray may be introduced into the gas-liquid absorption zone as droplets via a spray nozzle.

The spray nozzle operating pressure will be selected to produce a droplet having a mean droplet size selected to ensure a desired degree of gas mass transfer to achieve absorption of carbon dioxide in the ammoniated solution and effective gas scrubbing.

The flow rate of the ammoniated solution through the spray nozzle will be selected to produce a droplet having a mean droplet size selected to ensure a desired degree of gas mass transfer to achieve absorption of carbon dioxide in the ammoniated solution and effective gas scrubbing.

The spray nozzle may be configured to produce a droplet having a mean droplet size selected to ensure a desired degree of gas mass transfer to achieve absorption of carbon dioxide in the ammoniated solution and effective gas scrubbing.

The flue gas may be caused to flow through the gas-liquid absorption zone in a counter current direction with respect to the spray of ammoniated solution. Alternatively, the flue gas may be caused to flow through the gas-liquid absorption zone in a co-current direction with respect to the spray of ammoniated solution. In a still further embodiment, the flue gas may be caused to flow through the gas-liquid absorption zone in a cross-current direction with respect to the spray of ammoniated solution.

The flow rate of the flue gas in the gas-liquid absorption zone may be selected to ensure a desired degree of gas mass transfer to achieve absorption of carbon dioxide in the ammoniated solution and effective gas scrubbing.

The residence time of the flue gas in the gas-liquid absorption zone may be selected to ensure a desired degree of gas mass transfer to achieve absorption of carbon dioxide in the ammoniated solution and effective gas scrubbing.

The ammoniated solution-to-flue gas ratio (L/G) in the gas-liquid absorption zone may be selected to ensure a desired degree of gas mass transfer to achieve absorption of carbon dioxide in the ammoniated solution and effective gas scrubbing.

In another embodiment the flue gas may be passed directly through the ammoniated solution.

In an alternative embodiment the flue gas may be passed through an absorber relative to a flow of ammoniated solution. The flow of ammoniated solution may be in a counter-current direction to the flow of flue gas through the absorber.

Cooling the Flue Gas

The temperature of the flue gas exiting from a flue may be in the range of about 300° C. to about 800° C., depending on the process by which the flue gas is produced, the length of the flue, and other factors as will be understood by those skilled in the art. In view of the advantages provided by keeping the ammoniated solution at a relatively low temperature, it may be similarly beneficial to cool the flue gas prior to contacting it with the ammoniated solution. Accordingly, prior to contacting the flue gas with the ammoniated solution, the flue gas may be cooled to less than 30° C., in particular less than 25° C.

Cooling the flue gas may be achieved by expanding the flue gas through an expander.

Additionally, or alternatively, cooling the flue gas may be achieved by passing the flue gas through one or more heat exchangers. The heat exchangers may be air-cooled heat exchangers or water-cooled heat exchangers.

Additionally, or alternatively, cooling the flue gas may be achieved by mixing the flue gas with a lower temperature gas. In one embodiment, cooling the flue gas may be achieved by mixing the flue gas with ammonia gas prior to contacting the flue gas with the ammoniated solution.

Advantageously, the ammonia in the resulting flue gas-ammonia mixture will be absorbed and solubilised in the ammoniated solution when the flue gas-ammonia mixture is passed through the gas-liquid absorption zone, as described above.

Removing NOₓ and SOₓ from Flue Gas

Most environmental protection regulations have strict limitations on the amount of NOₓ and SOₓ that can be vented to atmosphere from flue gas emissions. Consequently, in order to comply with environmental regulations, many sources of flue gas emissions pass the flue gas through one or more pollutants control systems to remove or destroy the gaseous pollutant(s) before venting the flue gas to atmosphere. The pollutants control systems may be distinct and separate from any method or system to remove carbon dioxide from flue gas.

The method and system described herein may be readily adapted to remove NOₓ and SOₓ from flue gas.

In one embodiment, removing NOₓ and SOₓ from flue gas may comprise contacting the flue gas with ammonia in a catalytic converter mixing chamber. The catalytic converter mixing chamber may be integral with the expander described above. Alternatively, the catalytic converter mixing chamber may be disposed upstream from the expander. In another arrangement, the catalytic converter mixing chamber may be disposed downstream from the expander.

The catalytic converter mixing chamber may be configured to facilitate increased molecular collisions between NOₓ and SOₓ and ammonia in the presence of residual oxygen in the flue gas. In this way, SOₓ is oxidised to SO₃, and the NOₓ and NH₃ react to form nitrogen (N₂) and water. These products of the resultant reactions in the catalytic converter mixing chamber are readily carried by the flue gas and subsequently absorbed by the ammoniated solution when the flue gas is contacted with the ammoniated solution, as described above.

Contacting the Ammonium Bicarbonate Solution with a Sulphate Source

Subsequent to contacting the flue gas with an ammoniated solution to produce an ammonium bicarbonate solution, the method of removing carbon dioxide from flue gas also comprises contacting the ammonium bicarbonate solution with a sulphate source to produce a carbonate compound and an ammonium sulphate solution.

The term ‘sulphate source’ broadly refers to any form of sulphate ions capable of reacting with the ammonium bicarbonate solution to produce an ammonium sulphate solution. The sulphate source may take the form of one or more soluble metal sulphates, such as alkali earth metal sulphates like potassium sulphate and sodium sulphate. Alternatively, the sulphate source may take the form of sulphate solids. One suitable example of sulphate solids includes, but is not limited to, calcium sulphate (otherwise known as gypsum).

In a preferred embodiment, the sulphate source may comprise gypsum.

Advantageously, gypsum also provides a source of calcium ions which reacts with carbonate ions in solution to produce calcium carbonate as a solid according to the following reaction:

CaSO₄(s)+(NH₄)HCO₃(aq)→CaCO₃(s)+(NH₄)SO₄(aq)

In this way, carbon dioxide removed from the flue gas is converted into solid calcium carbonate. The solid calcium carbonate may be separated from the reaction mixture.

In one embodiment, contacting the ammonium bicarbonate solution with the sulphate source comprises mixing the sulphate source with the ammonium bicarbonate solution. The sulphate source may be mixed with the ammonium bicarbonate solution in stoichiometric amounts relative to the concentration of ammonium bicarbonate solution.

The sulphate source may be mixed with the ammonium bicarbonate solution with a mixer.

Separating the Carbonate Compound

The carbonate compound produced by the reaction of the sulphate source with the ammonium bicarbonate solution may be separated from the resulting ammonium sulphate solution in a separator.

It will be appreciated that the resulting ammonium sulphate solution may comprise a suitable precursor in a process to produce a fertilizer product.

Accordingly, the method described herein may be adapted to also produce fertilizer(s).

Fertilizer

The term ‘fertilizer’ broadly refers to any inorganic material that may be added to a soil to supply one or more plant nutrients essential to the growth of plants. The fertilizer may be a solid fertilizer in granulated or powdered form. Alternatively, the fertilizer may be a liquid fertilizer.

The fertilizer may be a nitrogen fertilizer containing ammonium or nitrate compounds. Additionally, or alternatively, the fertilizer may be a potassium fertilizer containing potassium compounds such as potassium chloride and/or potassium sulphate.

Producing Fertilizer from Flue Gas

The method of producing fertilizer from flue gas comprises the steps of:
contacting the flue gas with an ammoniated solution to produce an ammonium bicarbonate solution;
contacting the ammonium bicarbonate solution with a sulphate source to produce a carbonate compound and an ammonium sulphate solution;
separating the carbonate compound from the ammonium sulphate solution; and,
   utilizing the separated ammonium sulphate solution as a precursor in a process to produce a fertilizer product.

The flue gas may be contacted with the ammoniated solution to produce an ammonium bicarbonate solution, as has been described previously.

The ammonium bicarbonate solution may be contacted with a sulphate source to produce a carbonate compound (e.g. calcium carbonate) and an ammonium sulphate solution, and the solid calcium carbonate may be separated from the ammonium sulphate solution as has been described previously.

Utilizing the Separated Ammonium Sulphate Solution as a Fertilizer Precursor

The separated ammonium sulphate solution may be collected from the separator and fed to a reactor by conventional techniques as will be understood by a person skilled in the art.

The term ‘precursor’, in particular in relation to a ‘fertilizer precursor’, broadly refers to any substance used in the production of a fertilizer.

In one embodiment the ammonium sulphate solution may be used as a precursor to produce a fertilizer comprising ammonium sulphate. For example, the ammonium sulphate solution may be blended with other fertilizers, such as phosphorus fertilizers such as phosphoric acid, potassium fertilizers such as potassium chloride, potassium sulphate, or potassium nitrate, and/or other nitrogen fertilizers such as urea.

The blended fertilizer may be in liquid or solid form. The blended fertilizer may be mixed with a solid material such as lime or gypsum or other granulating agent(s) as will be well known to those skilled in the art. The mixture may then be dried and treated in accordance will well known techniques (e.g. in a fluid bed or rotary dryer) to produce a granulated blended fertilizer comprising ammonium sulphate. In the embodiment, the ammonium sulphate solution is not subjected to a chemical reaction but may be physically treated or blended with other fertilizers to produce a desired fertilizer product.

In an alternative embodiment, the ammonium sulphate solution may be used as a precursor to produce a potassium fertilizer. In this particular embodiment, utilizing the ammonium sulphate solution as a precursor comprises mixing the ammonium sulphate solution with potassium nitrate or potassium chloride in a manner to produce crystalline potassium sulphate.

In this particular embodiment, the ammonium sulphate solution may be heated to a temperature in a range of about 40° C. to about 80° C. Potassium nitrate or potassium chloride may be added to the heated ammonium sulphate solution in an amount where the resulting mixture is supersaturated. The heated mixture can then be cooled to a lower temperature (e.g. in a range of about 5° C. to about 25° C.), whereby potassium sulphate solids crystallise out of solution. The potassium sulphate crystals may be separated from the resulting supernatant by conventional separating techniques. The supernatant may, in turn, be used to produce a blended fertilizer as described above.

Apparatus for Removing Carbon Dioxide from Flue Gas

The apparatus for removing carbon dioxide from a flue gas comprises:
a gas-liquid absorption zone configured for contacting the flue gas with an ammoniated solution to produce an ammonium bicarbonate solution;
the gas-liquid absorption zone having respective inlets to receive the flue gas and the ammoniated solution in the gas-liquid absorption zone, and an outlet for egress of the ammonium bicarbonate solution; and,
a reactor configured for contacting the ammonium bicarbonate solution with a sulphate source to produce a carbonate compound and an ammonium sulphate solution;
   the reactor having respective inlets to receive the ammonium bicarbonate solution and the sulphate source in the reactor, and an outlet for egress of the carbonate compound and ammonium sulphate solution.

The apparatus may further comprise a separator for separating the carbonate compound from the ammonium sulphate solution.

It will be appreciated that a flow path of the flue gas will be configured to convey the flue gas to the gas-liquid absorption zone.

Gas-Liquid Absorption Zone

The term “gas-liquid absorption zone” refers generally to a zone of an apparatus in which absorption of a gas into a liquid occurs, by physical absorption processes and/or by chemisorption processes. This zone may comprise a column, duct or portion thereof, a structure or a vessel configured to provide a large surface area of contact between the gas and the liquid, and to keep both phases in vigorous motion to promote mixing therebetween.

The gas-liquid absorption zone may be configured to pass the flue gas in co-current flow, counter-current flow, or cross-current flow in relation to the ammoniated solution.

The gas-liquid absorption zone may be a packed column, in which the ammoniated solution runs as a film over an extensive surface of packing therein, while the flue gas is passed through the voids in the packing. The packing may be random packing or structured packing.

The gas-liquid absorption zone may be a spray column, in which the flue gas is contacted with a spray of ammoniated solution in the form of droplets.

The gas-liquid absorption zone may be a stirred vessel, in which the flue gas is entrained and dispersed in the ammoniated solution in the form of bubbles.

The gas-liquid absorption zone may be configured to have a volume, length and orientation to provide a sufficient residence time therein for both the flue gas and the ammoniated solution so that carbon dioxide (and SOₓ and NOₓ gases and their resultant catalysed products) may be absorbed into the ammoniated solution in the gas-liquid absorption zone.

Reactor to Produce Carbonate Compound and Ammonium Sulphate Solution

The reactor may be any vessel suitable for contacting the ammonium bicarbonate solution with a sulphate source to produce a carbonate compound and an ammonium sulphate solution.

The reactor may be provided with a mixer to facilitate contact between the ammonium bicarbonate solution and the sulphate source. Suitable examples of mixers include, but are not limited to, mechanical agitators such as propeller agitators and impellers, static agitators, rotating tank agitators, pump-driven fluid flow agitators, and gas driven agitators.

Mechanical agitators are particularly suitable to ensure dispersion of the sulphate source in the ammonium sulphate solution, in particular when the sulphate source is in a solid form (e.g. gypsum).

The reactor may also be configured to receive a flow of ammonium bicarbonate solution directed in a manner to scour the reactor. In this way, solid carbonate compounds such as calcium carbonate is prevented from settling at a base of the reactor and remains suspended in the ammonium bicarbonate/ammonium sulphate solution, thereby aiding subsequent separation of the calcium carbonate from the ammonium sulphate solution.

Separator

The separator may be any separator suitable for separating carbonate compounds, in particular solid carbonate compounds from the ammonium sulphate solution, as will be understood by the person skilled in the art. Examples of suitable separators include, but are not limited to, cyclones, filters such as filter press arrangements, filter-cloth separators, gravity separators, and so forth.

Cooling Means

The apparatus may further comprise a cooling means located upstream of the gas-liquid absorption zone for cooling the flue gas. The cooling means may take the form of one or more heat exchanger or an expander.

The heat exchanger may be any suitable heat exchanger, such as a shell and tube heat exchanger, plate heat exchanger, plate and shell heat exchanger, plate fin heat exchanger, and so forth. The heat exchanger may be air-cooled. Alternatively, the heat exchanger may employ an alternative gas or liquid coolant, such as water or a refrigerant, which is circulated through a refrigeration circuit and the heat exchanger by one or more pumps.

The expander may be any suitable device configured to expand the flue gas, thereby lowering its pressure and temperature. Examples of suitable expanders include, but are not limited to, venturi tubes, turbo expanders, pressure reducing valves, and so forth.

Catalytic Converter

The apparatus may be further provided with a catalytic converter to remove NOₓ and SOₓ components of the flue gas. The catalytic converter is configured to accelerate molecular collisions between the NOₓ and SOₓ components of the flue gas with oxygen, water and, optionally, ammonia to convert these components into NO₂, NH₃, and SO₃, respectively. Each of these latter gas species are water soluble and hydrolyse to NO₃⁻, NH₄⁺, and SO₄²⁻ in aqueous solution. Advantageously, these hydrolysed species are beneficial as fertilizer products.

The apparatus for removing carbon dioxide from flue gas may be adapted for producing fertilizer from the ammonium sulphate solution filtrate.

Apparatus for Producing Fertilizer from Flue Gas

The apparatus for producing fertilizer from flue gas comprises:

a gas-liquid absorption zone configured for contacting the flue gas with an ammoniated solution to produce an ammonium bicarbonate solution;
the gas-liquid absorption zone having respective inlets to receive the flue gas and the ammoniated solution in the gas-liquid absorption zone, and an outlet for egress of the ammonium bicarbonate solution;
a first reactor configured for contacting the ammonium bicarbonate solution with a sulphate source to produce a carbonate compound and an ammonium sulphate solution;
   the first reactor having respective inlets to receive the ammonium bicarbonate solution and the sulphate source in the reactor, and an outlet for egress of the carbonate compound and ammonium sulphate solution;
a separator to separate the carbonate compound from the ammonium sulphate solution; and,
a second reactor configured for utilizing the ammonium sulphate solution in a process to produce a fertilizer product.

The apparatus may further comprise means to convey the ammonium sulphate solution from the first reactor to the second reactor.

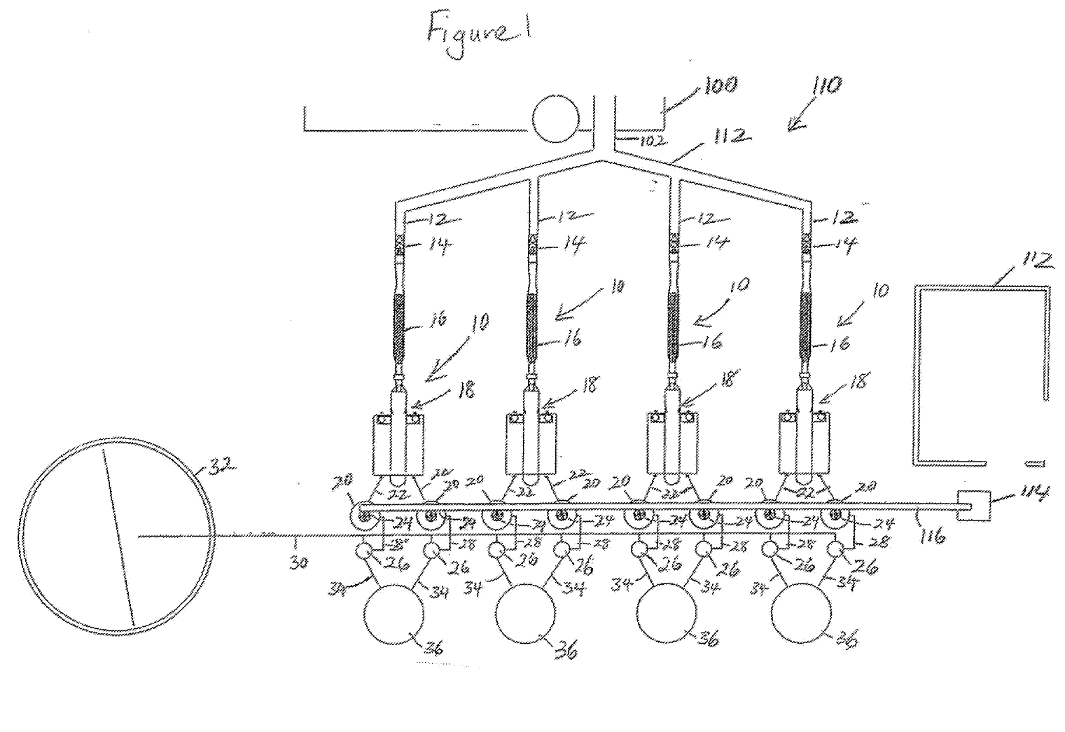

Various embodiments of the invention will now be described with reference to FIGS. 1 to 7, where like reference numerals are used to denote similar or like parts throughout,

Referring to FIGS. 1 to 6, one embodiment of the method and apparatus 10 for removing carbon dioxide from flue gas will now be described. In this particular embodiment, the apparatus 10 has been adapted for producing potassium sulphate as a fertilizer byproduct.

FIG. 1 illustrates the juxtaposition of a power station 100 (e.g. a coal-fired or gas-fired power station) that produces flue gas with a fertilizer plant 110 comprising the apparatus 10 described herein to employ a method of removing carbon dioxide from flue gas. The fertilizer plant 110 comprises a plurality of the apparatuses 10 arranged in parallel. It will be appreciated that a detailed description of a single apparatus 10 similarly applies to any one of the plurality of apparatuses 10 arranged in parallel.

Flue gas is emitted from the power station 100 via a flue 102. The flue 102 may be configured in fluid communication with a manifold 112 which may be arranged to regulate flue gas flow between the flue 102 and respective inlets 12 of a plurality of apparatuses 10 for removing carbon dioxide from flue gas.

Downstream of the inlet 12 may be a catalytic converter 14 for treatment of NOₓ and SOₓ gases in the flue gas. A heat exchanger 16 may be located downstream of the catalytic converter 14 for cooling the flue gas to a temperature less than 30° C. The cooled flue gas may be then directed to a gas-liquid absorption zone 18 wherein the cooled flue gas may be contacted with an ammoniated solution in a manner to produce an ammonium bicarbonate solution.

The ammonium bicarbonate solution may be conveyed from the gas-liquid absorption zone 18 to a first reactor 20 via conduit 22. The first reactor 20 may be provided with a mixer 24, such as an impeller.

The fertilizer plant 110 may be provided with a bunker 112 for storage of a sulphate source, such as gypsum. The sulphate source may be fed to the plurality of first reactors 18 from a hopper 114 associated with the bunker 112 via a conveyor 116, such as a conveyor belt.

The mixer 24 may agitate a mixture of the sulphate source with the ammonium bicarbonate solution in the first reactor 20 to produce a reaction mixture of calcium carbonate solids suspended in an ammonium sulphate solution.

The reaction mixture may be conveyed from the first reactor 20 to a separator 26, such as a centrifuge or a press plate filter via conduit 28. A resultant slurry containing calcium carbonate may be conveyed via conduit 30 to a thickening tank 32 for further thickening and settling processes which will be well understood by those skilled in the art. The separated ammonium sulphate solution may flow via conduit 34 to a storage tank 36. It will be appreciated that the separated ammonium sulphate may be further treated in a second reactor (not shown in FIG. 1) as a precursor for one or more fertilizer products.

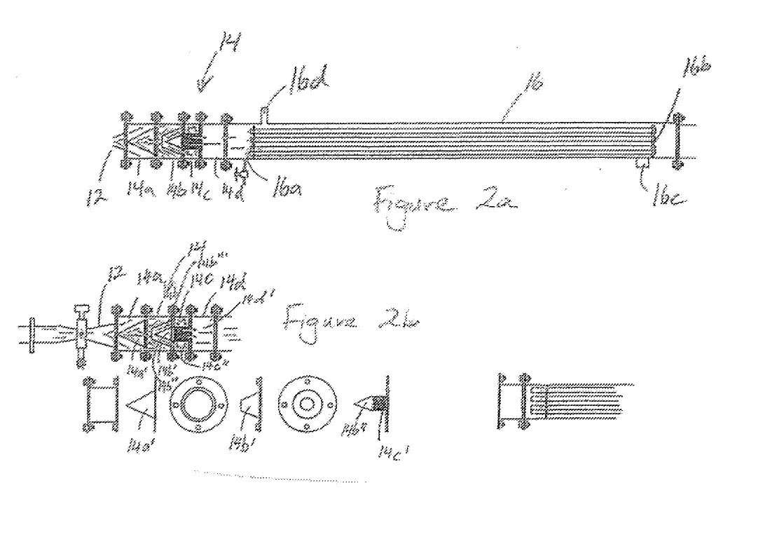

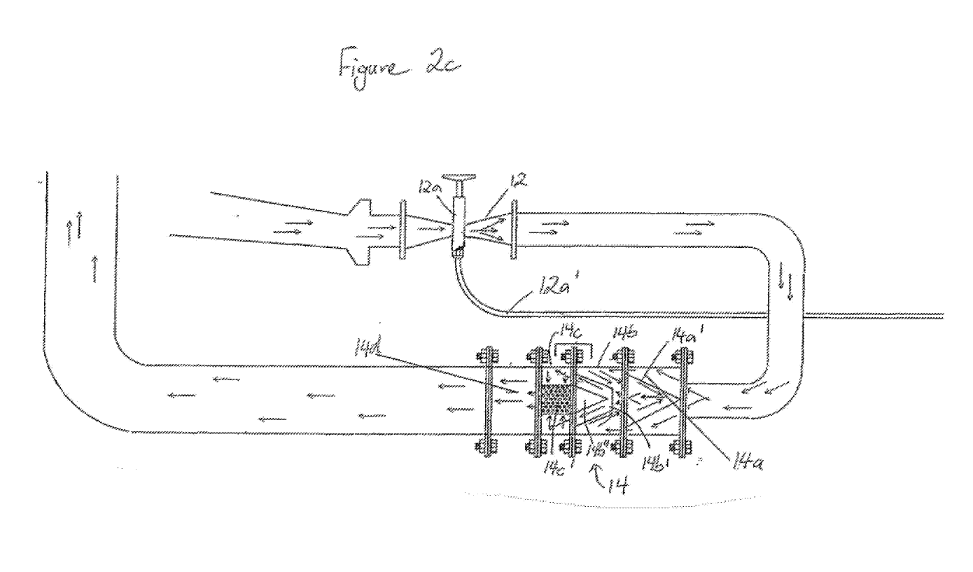

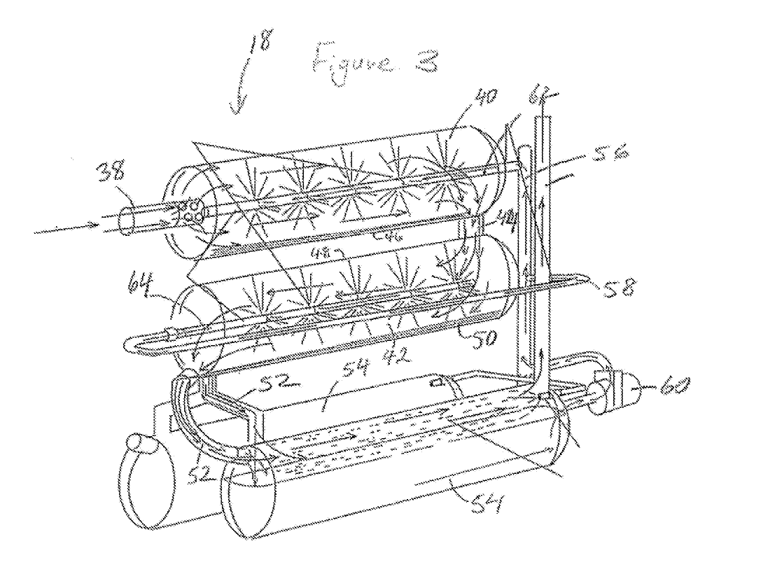

A detailed arrangement of the catalytic converter 14 and the heat exchanger 16 is shown in FIGS. 2a-2c.

The catalytic converter 14 comprises a plurality of sequentially configured cylindrical sections 14a, 14b, 14c and 14d arranged in-line between inlet 12 and the heat exchanger 16.

In this specific embodiment, inlet 12 is integral with an expander in the form of a venturi tube, to expand and thereby cool the flue gas, at least in part, prior to the flue gas passing through the catalytic converter 14. The inlet 12 may also be provided with an ammonia control valve 12a which is configured in operative fluid communication with an ammonia line 12a′. The ammonia control valve 12a controls ingress of ammonia gas into the inlet 12 for mixing with the flue gas before passing through the catalytic converter 14.

Cylindrical section 14a is adjacent to the expander. The cylindrical section 14a is configured to be integral with the expander, thereby further expanding the flue gas and reducing its temperature. Cylindrical section 14a is provided with an upstream-directed conical element 14a′. The circumferential base of the conical element 14a′ is marginally narrower than the internal circumference of the cylindrical sections 14a, 14b, 14c, 14d, thereby restricting passage of the flue gas to the adjacent cylindrical section 14b from around the perimeter of its circumferential base of the conical element 14a′.

Cylindrical section 14b is disposed between cylindrical sections 14a, 14c. Cylindrical section 14b is provided with an upstream-directed truncated conical element 14b′. The circumferential base of the truncated conical element 14b′ is narrower than the internal circumference of the cylindrical sections 14a, 14b, 14c, 14d and marginally narrower than the circumferential base of the conical element 14a′.

Cylindrical section 14c is disposed between cylindrical sections 14b, 14d. Cylindrical section 14c is provided with an upstream-directed cylindrical element 14c′ provided with a conical cap 14b″ which is configured to protrude into cylindrical section 14b. Conical cap 14b″ is disposed concentrically and spaced apart from truncated conical element 14b′, thereby forming a truncated conical chamber 14b″ in cylindrical section 14b. Cylindrical element 14c′ defines an annular chamber 14c″ in cylindrical section 14c.

Cylindrical section 14d is disposed between cylindrical section 14c and an upstream end 16a of the heat exchanger 16. Cylindrical section 14d is configured to define a cylindrical chamber 14d′ therewithin.

The inventor opines that the pathway of the flue gas through the consecutively arranged cylindrical sections 14a, 14b, 14c, 14d of the catalytic converter 14 increases the molecular collisions between the NOₓ and SOₓ components of the flue gas with oxygen, water and, optionally, ammonia to convert these components into NO₂, NH₃, and SO₃, respectively. The converted species are then conveyed by the flue gas through the heat exchanger 16. Advantageously, the inventor has found that catalytic conversion of the NOₓ and SOₓ components of the flue gas, as described above, reduces the ammonia feed requirement for the ammoniated solution.

In this specific embodiment, the heat exchanger 16 is a water-cooled shell and tube heat exchanger. The heat exchanger has an inlet 16c for receiving a water coolant and an outlet 16d for discharging spent (heated) water coolant. It will be appreciated that the water coolant may be circulated through a refrigeration circuit or chiller to regenerate the water coolant (not shown). It will also be appreciated that any liquid or gas coolant suitable for cooling the flue gas to a temperature less than 30° C. could be employed.

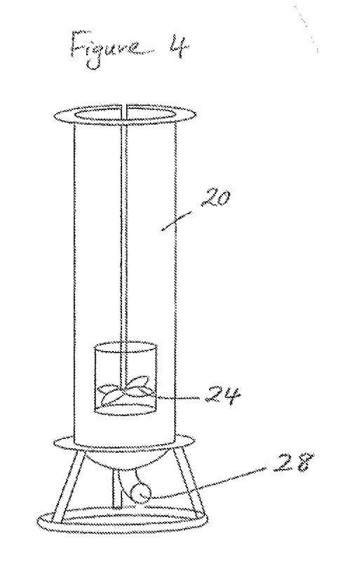

The cooled flue gas may be then directed to an inlet 38 of the gas-liquid absorption zone 18, as shown in FIG. 3, wherein the cooled flue gas may be contacted with an ammoniated solution in a manner to produce an ammonium bicarbonate solution. The inlet 38 may be configured to disperse a plume of flue gas into the gas-liquid absorption zone 18.

Referring to FIG. 3, the gas-liquid absorption zone 18 is defined by a first horizontally disposed vessel 40 in fluid communication with a second horizontally disposed vessel 42 via drain 44. The drain 44 is disposed in an opposing end of the first vessel 40 relative to the inlet 38. Said second vessel 42 is arranged below and in parallel vertical alignment with said first horizontally disposed vessel 40. Drain 44 interconnects a lower wall 46 of said first vessel 40 with an upper wall 48 of the second vessel 42. In this way, gas and liquid which has collected on the lower wall 46 of the first vessel 40 may flow into the second vessel 42.

A lower wall 50 of the second vessel 42 is also provided with a drain 52 which may be in selective alternate fluid communication with one or the other of a pair of tanks 54 for storing ammoniated solution and/or ammonium bicarbonate solution. Selection of one or the other of the pair of tanks 54 may be achieved with a control valve assembly (not shown), as will be described later. The drain 52 is disposed in an opposing end of the second vessel 42 relative to the drain 44.

The tank 54 is arranged, in use, to circulate ammoniated solution via conduits 56, 58 to the first and second vessels 40, 42 respectively. Tank 54 is provided with a pump 60 to circulate the ammoniated solution to the first and second vessels 40, 42 under pressure.

Conduit 56 is in fluid communication with a spray tube 62 disposed along a central longitudinal axis of the first vessel 40. Conduit 58 is in fluid communication with a spray tube 64 disposed along a central longitudinal axis of the second vessel 42. Spray tubes 62, 64 are respectively provided with a plurality of spaced apart 360° spray radials configured to deliver a plurality of spray plumes of ammoniated solution in the first vessel 40 and the second vessel 42, respectively.

In operation, cooled flue gas enters the first vessel 40 through inlet 38 and is directed towards an opposing end of the first vessel 40 in counter-current flow to a series of sprays of ammoniated solution from spray tube 62. The flue gas contacts and mixes with the ammoniated solution and drains/flows through the drain 44 into the second vessel 42.

The flue gas then flows from one end of the second vessel 42 to the opposing end thereof in counter-current flow to a series of sprays of ammoniated solution from spray tube 64. The flue gas contacts and mixes with the ammoniated solution and drains/flows through the drain 52 into the tank 54.

Notwithstanding that the solution draining into the tank 54 may comprise ammonium bicarbonate solution, the ammoniated solution (mixed with ammonium bicarbonate solution) is continuously recirculated through the spray tubes 62, 64 until the ammoniated solution reaches its absorptive capacity with respect to carbon dioxide. In other words, the ammoniated solution in the tank is recirculated through the spray tubes 62, 64 until it is substantially converted to ammonium bicarbonate solution. When the ammoniated solution reaches its absorptive capacity with respect to carbon dioxide, the control valve assembly may selectively switch to the other of the pair of tanks 54 and the process may continue. The absorptive capacity of the ammoniated solution with respect to carbon dioxide may be monitored by any suitable sensor capable of measuring the concentration of carbon dioxide, carbonate or bicarbonate in solution.

When the ammoniated solution reaches its absorptive capacity with respect to carbon dioxide, the ammonium bicarbonate solution from the first of the tanks 54 may then be directed to the first reactor 20 via conduit 22. It will be appreciated that when the ammoniated solution reaches its absorptive capacity with respect to carbon dioxide in the second of the tanks 54, the ammonium bicarbonate solution will similarly be directed to the first reactor 20 via conduit 22.

The resulting CO₂-depleted flue gas residing in the headspace of the tank 54, having passed through the first and second vessels 40, 42, may then be vented to atmosphere via conduit 66.

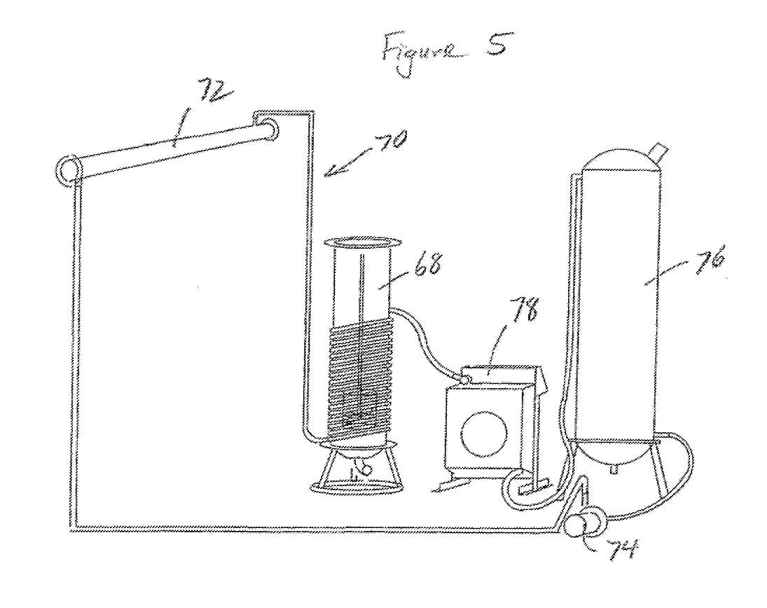

Referring now to FIG. 4, the ammonium bicarbonate solution from the gas-liquid absorption zone 18 may be directed to the first reactor 20 via conduit 22. A sulphate source, such as gypsum, may be mixed with the ammonium bicarbonate solution with a mixer 24 to produce calcium carbonate and ammonium sulphate solution. The calcium carbonate may be separated from the ammonium sulphate solution with a separator, such as a filer press (not shown).

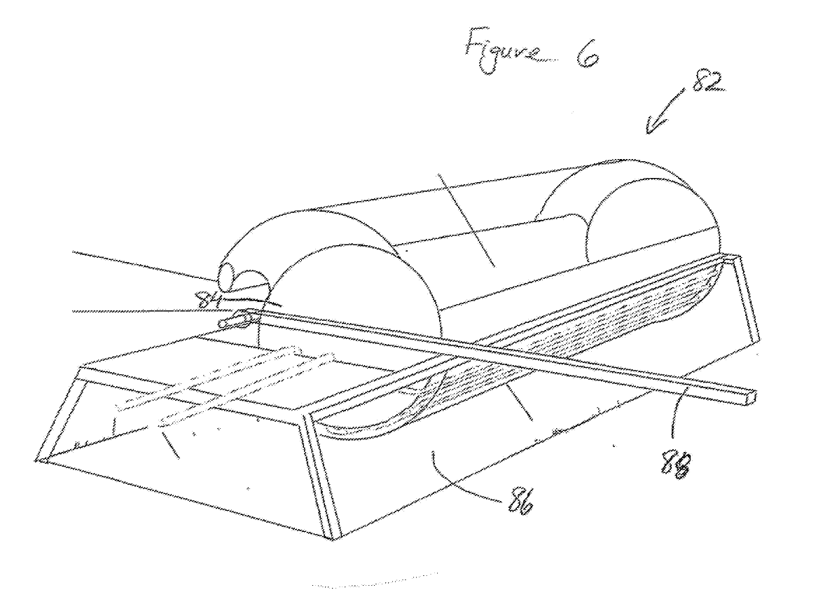

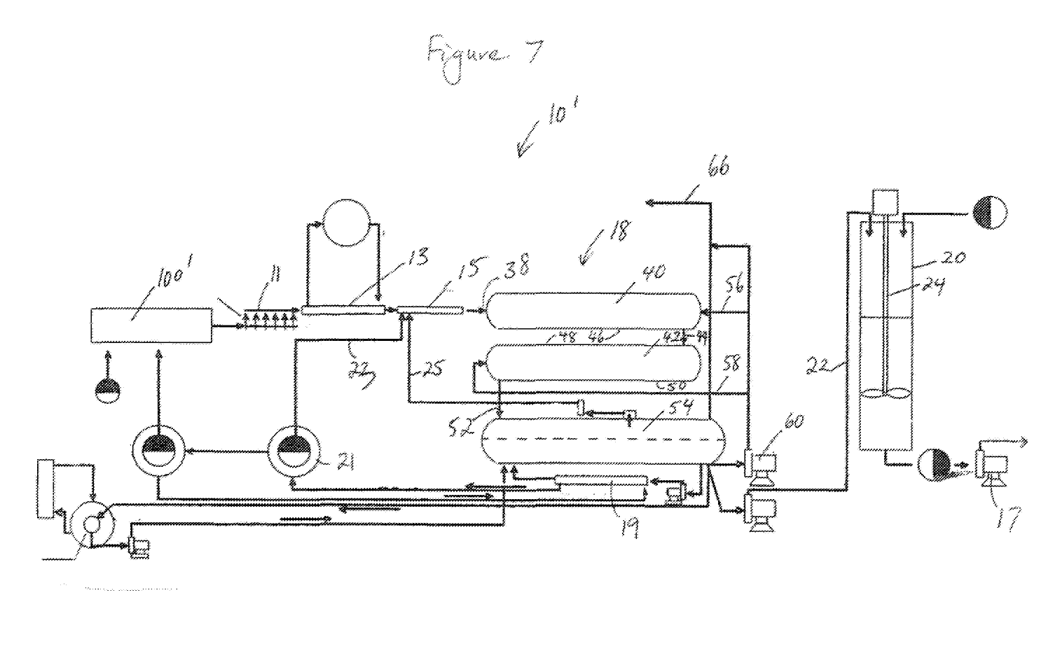

The ammonium sulphate filtrate may then be used as a precursor for a fertilizer product, as will now be described with reference to FIGS. 5 and 6.

The ammonium sulphate filtrate may be directed to a second reactor 68 and heated to about 60° C. The second reactor 68 may be configured in a heating circuit 70 comprising a heat exchanger 72, a pump 74, a coolant vessel 76 containing coolant, and a radiator 78. In some embodiments, the heat exchanger 72 may be in fluid communication with heat exchanger 16. Alternatively, heat exchanger 72 of the heating circuit 70 may be heat exchanger 16.

The second reactor 68 is provided with a mixer 80 for mixing the ammonium sulphate filtrate with a reactant. In this specific embodiment, the reactant may be a potassium salt, such as potassium chloride or potassium nitrate. The potassium salt is soluble in water and readily dissolves in the heated ammonium sulphate filtrate, thereby forming a heated supersaturated solution of potassium sulphate.

The heated supersaturated solution of potassium sulphate is subsequently directed to a crystallization vessel 82 as shown in FIG. 6. The crystallization vessel 82 comprises a pivotable vessel 84 submerged in a chilled water bath 86 or, alternatively, in thermal exchange with a refrigerant. The heated supersaturated solution of potassium sulphate is chilled in the crystallization vessel 82. As the temperature of said solution decreases, the solubility of potassium sulphate in solution also decreases and crystals and/or solids of potassium sulphate begin to form.

When the crystallization of potassium sulphate is complete, the pivotable vessel 84 can be pivoted by means of a lever fulcrum 88 to decant the supernatant potassium sulphate solution which can be subsequently be used as a precursor for other fertilizer products, as will be well understood to those skilled in the art. The potassium sulphate solids (crystals) may then be collected from the pivotable vessel 84, dried, for example in a rotary drier, and subsequently stored.

Referring now to FIG. 7, there is shown an alternative embodiment of the apparatus 10′ for removing carbon dioxide from flue gas.

Flue gas is emitted from motor 100′ via a flue 102. The temperature of the flue gas may vary depending on the fuel source used for combustion in the motor 100′ and the air-fuel source ratio, but for the purposes of illustration the temperature of the flue gas emitted from motor 100′ is about 470° C. Passage of the flue gas through flue 102 may cool the flue gas to about 170° C. The flue 102 may be configured in fluid communication with an air-cooled heat exchanger 11 which is arranged to cool the flue gas from about 170° C. to about 80° C. The apparatus 10′ further includes a water-cooled heat exchanger 13 which is configured in series with the air-cooled heat exchanger 11. Flue gas passes from the air-cooled heat exchanger 11 to the water-cooled heat exchanger 13, whereby the temperature of the flue gas is further cooled by passage through the water-cooled heat exchanger 13 to about 23° C.

The cooled flue gas is then passed into pipe vessel 15 and mixed with chilled ammonia gas from ammonia chiller 21. Ammonia sourced from the head space of vessel 54 via conduit 25 may also be mixed with the cooled flue gas. As a result of exothermic reaction between components in the cooled flue gas and ammonia, the temperature of the flue gas-ammonia mixture rises to about 33° C. as it exits the pipe vessel 15.

The flue gas-ammonia mixture may be then directed to an inlet 38 of the gas-liquid absorption zone 18, wherein the flue gas-ammonia mixture is contacted with an ammoniated solution in a manner to produce an ammonium bicarbonate solution. The inlet 38 may be configured to disperse a plume of the flue gas-ammonia mixture into the gas-liquid absorption zone 18.

The gas-liquid absorption zone 18 includes first horizontally disposed vessel 40 in fluid communication with a second horizontally disposed vessel 42 via drain 44. The drain 44 is disposed in an opposing end of the first vessel 40 relative to the inlet 38. Said second vessel 42 is arranged below and in parallel vertical alignment with said first horizontally disposed vessel 40. Drain 44 interconnects a lower wall 46 of said first vessel 40 with an upper wall 48 of the second vessel 42. In this way, gas and liquid which has collected on the lower wall 46 of the first vessel 40 flows into the second vessel 42.

A lower wall 50 of the second vessel 42 is also provided with a drain 52 which may be in selective alternate fluid communication with one or the other of a pair of tanks 54 for storing ammoniated solution and/or ammonium bicarbonate solution. Selection of one or the other of the pair of tanks 54 may be achieved with a control valve assembly. The drain 52 is disposed in an opposing end of the second vessel 42 relative to the drain 44.

The tank 54 is arranged, in use, to circulate ammoniated solution via conduits 56, 58 to the first and second vessels 40, 42 respectively. Tank 54 is provided with a pump 60 to circulate the ammoniated solution to the first and second vessels 40, 42 under pressure.

Conduit 56 is in fluid communication with a spray tube (not shown) disposed along a central longitudinal axis of the first vessel 40. Conduit 58 is in fluid communication with a spray tube (not shown) disposed along a central longitudinal axis of the second vessel 42. Spray tubes, as have been described previously, are respectively provided with a plurality of spaced apart 360° spray radials configured to deliver a plurality of spray plumes of ammoniated solution in the first vessel 40 and the second vessel 42, respectively.

In operation, cooled flue gas-ammonia mixture enters the first vessel 40 through inlet 38 and is directed towards an opposing end of the first vessel 40 in counter-current flow to a series of sprays of ammoniated solution. The flue gas contacts and mixes with the ammoniated solution and drains/flows through the drain 44 into the second vessel 42. Typically, the temperature of the liquid-gas mixture leaving the first vessel 40 is about 34° C.

The flue gas then flows from one end of the second vessel 42 to the opposing end thereof in counter-current flow to a series of sprays of ammoniated solution. The flue gas contacts and mixes with the ammoniated solution and drains/flows through the drain 52 into the tank 54. Typically, the temperature of the liquid-gas mixture leaving the second vessel is about 35° C.

Notwithstanding that the solution draining into the tank 54 may comprise ammonium bicarbonate solution, the ammoniated solution (mixed with ammonium bicarbonate solution) is continuously recirculated through the conduits 56, 58 and the first and second vessels 40, 42 until the ammoniated solution reaches its absorptive capacity with respect to carbon dioxide. In other words, the ammoniated solution in the tank is recirculated through the conduits 56, 58 and the first and second vessels 40, 42 until it is substantially converted to ammonium bicarbonate solution. When the ammoniated solution reaches its absorptive capacity with respect to carbon dioxide, the control valve assembly may selectively switch to the other of the pair of tanks 54 and the process may continue. The absorptive capacity of the ammoniated solution with respect to carbon dioxide may be monitored by any suitable sensor capable of measuring the concentration of carbon dioxide, carbonate or bicarbonate in solution.

The temperature of the ammonium bicarbonate solution in tank 54 may be maintained at less than 30° C. In the embodiment shown in FIG. 7, the ammonium bicarbonate solution in tank 54 may be cooled by circulating said solution through heat exchanger 19 in heat exchange relation with a refrigerant, preferably an ammonia refrigerant, from ammonia chiller 21. Ammonia chiller 21 may supply ammonia gas to pipe vessel 15 through conduit 23.

When the ammoniated solution reaches its absorptive capacity with respect to carbon dioxide, the ammonium bicarbonate solution from the first of the tanks 54 may then be directed to the first reactor 20 via conduit 22. It will be appreciated that when the ammoniated solution reaches its absorptive capacity with respect to carbon dioxide in the second of the tanks 54, the ammonium bicarbonate solution will similarly be directed to the first reactor 20 via conduit 22.

The resulting CO₂-depleted flue gas residing in the headspace of the tank 54, having passed through the first and second vessels 40, 42, may then be vented to atmosphere via conduit 66. It will be appreciated that the CO₂-depleted flue gas may be optionally passed through a scrubber prior to venting to atmosphere.

A sulphate source, such as gypsum, may be mixed with the ammonium bicarbonate solution in the first reactor 20 with a mixer 24 to produce calcium carbonate and ammonium sulphate solution. The calcium carbonate-ammonium bicarbonate solution may be transferred via liquid transfer pump 17 to a separator, such as a filer press (not shown).

As will be evident from the foregoing description, the process of the present invention facilitates a reduction of greenhouse gas emissions (i.e. carbon dioxide) in comparison with conventional technologies for treating flue gas.

A financial instrument tradable under a greenhouse gas Emissions Trading Scheme (ETS) may be created by juxtaposing a fertilizer plant and a flue gas emissions source, such as an industrial power plant, in a manner whereby the processes of the present invention may be readily employed. The instrument may be, for example, one of either a carbon credit, carbon offset or renewable energy certificate. Generally, such instruments are tradable on a market that is arranged to discourage greenhouse gas emission through a cap and trade approach, in which total emissions are ‘capped’, permits are allocated up to the cap, and trading is allowed to let the market find the cheapest way to meet any necessary emission reductions. The Kyoto Protocol and the European Union ETS are both based on this approach.

One example of how credits may be generated by using the fertilizer plant as follows. A person in an industrialised country wishes to get credits from a Clean Development Mechanism (CDM) project, under the European ETS. The person contributes to the establishment of a fertilizer plant employing the processes of the present invention in proximal vicinity to a source of flue gas emissions. Credits (or Certified Emission Reduction Units where each unit is equivalent to the reduction of one metric tonne of CO₂ or its equivalent) may then be issued to the person. The number of CERs issued is based on the monitored difference between the baseline and the actual emissions. It is expected by the applicant that offsets or credits of a similar nature to CERs will be soon available to persons investing in low carbon emission energy generation in industrialised nations, and these could be similarly generated.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of removing carbon dioxide from a flue gas, the method comprising;
cooling the flue gas to less than 30° C.;
contacting the flue gas with an ammoniated solution to produce an ammonium bicarbonate solution; and,
contacting the ammonium bicarbonate solution with a sulphate source to produce a carbonate compound and an ammonium sulphate solution.

2. The method according to claim 1 further comprising recovering the carbonate compound by separating the carbonate compound from the ammonium sulphate solution.

3. The method according to claim 1, wherein the ammoniated solution is ammonium hydroxide.

4. The method according to claim 1, wherein the concentration of ammonia in the ammoniated solution is in the range of about 5% w/v to about 30% w/v.

5. The method according to claim 1, wherein the pH of the ammoniated solution is in the range of about 9 to about 11.

6. The method according to claim 1, wherein the temperature of the ammoniated solution is from about 5° C. to about 30° C.

7. (canceled)

8. The method according to claim 1, wherein contacting the flue gas with the ammoniated solution comprises passing the flue gas and the ammoniated solution through a gas-liquid absorption zone.

9. The method according to claim 8, wherein the ammoniated solution is dispersed in the gas-liquid absorption zone in the form of a spray.

10. (canceled)

11. The method according to claim 9, wherein the flue gas is caused to flow through the gas-liquid absorption zone in one of a counter current direction with respect to the spray of ammoniated solution, a co-current direction with respect to the spray of ammoniated solution, and a cross current direction with respect to the spray of ammoniated solution.

12. (canceled)

13. (canceled)

14. The method according to claim 8, wherein the flue gas is passed directly through the ammoniated solution.

15. The method according to claim 1, wherein cooling the flue gas comprises one of expanding the flue gas through an expander, passing the flue gas through one or more heat exchangers, and mixing the flue gas with a lower temperature gas.

16. (canceled)

17. (canceled)

18. The method according to claim 15, wherein the lower temperature gas is ammonia gas.

19. The method according to claim 1 further comprising removing NOₓ and SOₓ from flue gas, wherein prior to contacting the flue gas with the ammoniated solution, the flue gas is passed through a catalytic converter mixing chamber to convert NOₓ and SOₓ into NO₂, NH₃ and SO₃.

20. The method according to claim 1, wherein the carbonate compound is calcium carbonate.

21. The method according to claim 20, wherein the sulphate source is calcium sulphate.

22. An apparatus for removing carbon dioxide from a flue gas, the apparatus comprising:
a cooling means for cooling the flue gas to less than 30° C.;
a gas-liquid absorption zone configured for contacting the flue gas with an ammoniated solution to produce an ammonium bicarbonate solution;
the gas-liquid absorption zone having respective inlets to receive the flue gas and the ammoniated solution in the gas-liquid absorption zone, and an outlet for egress of the ammonium bicarbonate solution; and,
a reactor configured for contacting the ammonium bicarbonate solution with a sulphate source to produce a carbonate compound and an ammonium sulphate solution;
the reactor having respective inlets to receive the ammonium bicarbonate solution and the sulphate source in the reactor, and an outlet for egress of the carbonate compound and ammonium sulphate solution.

23. The apparatus according to claim 22, the apparatus further comprising a separator for separating the carbonate compound from the ammonium sulphate solution.

24. The apparatus according to claim 22, wherein the cooling means comprises one of an expander disposed upstream of the flue gas inlet of the gas-liquid absorption zone and a heat exchanger disposed upstream of the flue gas inlet of the gas-liquid absorption zone.

25. (canceled)

26. The apparatus according to claim 22, wherein the apparatus comprises a catalytic converter mixing chamber for converting NOₓ and SOₓ to NO₂, NH₃ and SO₃, said catalytic converter mixing chamber being disposed upstream of the flue gas inlet of the gas-liquid absorption zone.

27. The apparatus according to claim 22, wherein the gas-liquid absorption zone comprises a packed column or a spray column.

28. (canceled)

29. (canceled)

30. The apparatus according to claim 22, wherein the gas-liquid absorption zone comprises a horizontally disposed vessel having a first end and a second end, the inlet for the receiving the flue gas being disposed at or near the first end and the outlet for egress of the ammonium bicarbonate solution being disposed at or near the second end; and a spray tube disposed along a central longitudinal axis of said vessel, the spray tube being provided with a plurality of spaced apart spray radials configured, in use, to deliver a plurality of spray plumes of ammoniated solution in said vessel, wherein an open end of the spray tube defines the inlet for receiving the ammoniated solution.

31. The apparatus according to claim 30, wherein the outlet for egress of the ammonium bicarbonate solution is in fluid communication with a reservoir for the ammoniated solution, in an arrangement whereby ammonium bicarbonate solution produced in the gas-liquid absorption zone drains into and mixes with the ammoniated solution in the reservoir, the apparatus further comprising a means to recirculate the mixed ammonium bicarbonate/ammoniated solution to the open end of the spray tube.

32. The apparatus according to claim 22, wherein the carbonate compound is calcium carbonate.

33. A method of producing fertilizer from flue gas, the method comprising:
cooling the flue gas to less than 30° C.;
contacting the flue gas with an ammoniated solution to produce an ammonium bicarbonate solution;
contacting the ammonium bicarbonate solution with a sulphate source to produce a carbonate compound and an ammonium sulphate solution;
separating the carbonate compound from the ammonium sulphate solution; and,
utilizing the separated ammonium sulphate solution in a process to produce a fertilizer product.

34. A system for producing fertilizer from flue gas, the system comprising:
a cooling means for cooling the flue gas to less than 30° C.;
a gas-liquid absorption zone configured for contacting the flue gas with an ammoniated solution to produce an ammonium bicarbonate solution;
the gas-liquid absorption zone having respective inlets to receive the flue gas and the ammoniated solution in the gas-liquid absorption zone, and an outlet for egress of the ammonium bicarbonate solution;
a first reactor configured for contacting the ammonium bicarbonate solution with a sulphate source to produce a carbonate compound and an ammonium sulphate solution;
the first reactor having respective inlets to receive the ammonium bicarbonate solution and the sulphate source in the reactor, and an outlet for egress of the carbonate compound and ammonium sulphate solution;
a separator to separate the carbonate compound from the ammonium sulphate solution; and,
a second reactor configured for utilizing the ammonium sulphate solution in a process to produce a fertilizer product.

35. A method of creating a financial instrument tradable under a greenhouse gas Emissions Trading Scheme (ETS), the method comprising the step of exploiting a method for removing carbon dioxide from flue gas according to claim 1.

36. The method according to claim 35, wherein the financial instrument comprises one of either a carbon credit, carbon offset or renewable energy certificate.
